(19) United States
(12) Patent Application Publication
(10) Pub. No.: US 2006/0222817 A1
(43) Pub. Date: Oct. 5, 2006

(54) Industrial protective systems

(76) Inventors: Dennis A. Pauze, Tucson, AZ (US); Charles D. Bitner III, Morenci, AZ (US); Stacey A. MacDonald, Phoenix, AZ (US)

Correspondence Address: GALLAGHER & KENNEDY, P. A., 2575 E. CAMELBACK RD. #1100, PHOENIX, AZ, 85016, US

(21) Appl. No.: 11/096,347

(22) Filed: Apr. 1, 2005

(51) Int. Cl. B32B 3/02; B32B 3/10

(52) U.S. Cl. 428/157; 428/138; 428/192

(57) ABSTRACT

A cathode blank used in electrolysis of metal having an improved edge strip. The edge strip is made of a polyurethane formulation having desirable characteristics that prevent electrolyte from leaking into edge strip covered portions of the cathode blank. The edge strip may be molded onto the cathode blank. Alternatively, the polyurethane formulation may also be injected into voids of preexisting edge strips.

### FIELD OF THE INVENTION

This invention relates to metal electrodes and more particularly to edge strips formed on cathodes used in metal electrolysis and the method of making those edge strips.

### BACKGROUND OF THE INVENTION

In electrolysis of metal, electrical current is passed from anodes through a metal-containing electrolyte (e.g., sulfuric acid) to sheet-like blanks that serve as cathodes. The metal is deposited on the blanks by electrolysis. If the metal were allowed to grow along the entire blank, encircling it, it would be very difficult to harvest the metal growth, which is typically a 7-day growth that has accumulated on the blank. The blanks are pulled from the bath and flexed to cause the metal growth to be released. Along two or three edges of the blanks that form the cathodes, edge strips are positioned to prevent the metal growth from extending around the edges of the blanks.

Damage to the outer surfaces of the edge strips is a problem. Exterior surface cracks, cuts, gouges, and nicks on the outer surface of the edge strips are caused by everyday operating procedures such as transportation of the cathodes to receiving racks when harvesting the metal, stripping and transporting back to electrolytic cells.

Damaged areas can allow electrolyte to penetrate through or under the edge strips resulting in irreparable damage to the strips. Essentially a bad situation quickly becomes a hopeless one. As the damaged areas permit acid to penetrate through the edge strips, deposited metal grows. This means that the protected edge around the blank is now exposed. Once deposited metal contained in the electrolyte bath attaches itself to the exposed portions of the blank, it grows to form a nodule. This nodule continues to grow larger over the seven day growth period. The longer the blank is submerged in the electrolyte bath, the larger the nodule(s) will grow. As the nodule grows, it pushes against the edge strip, forcing the cracks, gouges and the like to enlarge and forcing the edge strip away from the blank to further expose the previously covered portions of the blank to the electrolyte bath. Once this happens, the edge strip must be replaced as repairs to it are not feasible.

Corners present an additional area of concern for three-sided edge strips. When installing a bottom edge strip on the blank, corner pieces are glued to the side edge strip. All three separate pieces are glued together. Those corners cannot be adequately sealed so eventually acid finds a void or deteriorates the glue exposing the previously covered portions of the blank, which in turn causes nodule growth that damages the edge strip as described.

A two-sided edge strip, on the other hand, has an additional bottom plug problem. These plugs are attached to the bottom of the edge strip, some are glued on and some are molded to the edge strip. Again, failures are caused by either acid attacking the glue or by mechanical abuse during transportation and stripping of deposited metal. Once again, nodules grow on the exposed portions of the blank that were intended to be covered by the edge strip. This exposure leads to the previously described irreparable damage.

### BRIEF SUMMARY OF THE INVENTION

In accordance with the present invention, edge strips are molded or sprayed in-situ onto cathode blanks. By this means, a polyurethane edge strip is mechanically attached to the external edges of the blanks. While this edge strip covers the same outer edge as the current plastic edge strips, it is narrower and allows more metal to deposit on each blank. This is a production increase with bottom line impact.

Three-sided edge strips formed in accordance with the invention are monolithic. Where previously corner pieces commonly admitted acid to the underlying portions of the blank, this inhibits the growth of deposited metal. Unlike prior edge strip technologies, spot repairs are easy and quick. Reapplication of the mold or respraying permits the formation in-situ of a new section of edge strip where a damaged area has been removed.

Polyurethane provides a significantly improved edge strip by virtue of its resistance to the electrolyte and its greater endurance to physical abuse. The edge strips last longer. The manufacturing process to apply the polyurethane edge strip provides substantial cost savings compared to current systems. Linear thermal elongation of the polyurethane edge strip offers superior performance when the blanks are flexed to remove metal deposited thereon.

In one preferred embodiment, the edge strip may comprise a polyurethane formulation, such as that used in tank liners.

In addition, because the improved edge strips need to be removed and replaced less often, substantial labor savings result. Because the polyurethane is substantially 100% solid and inert and even after usage is solvent, CFC, HCFC and VOC-free, disposal is a non-issue. There is no need to haul the polyurethane edge strips to a hazardous waste facility. The regulatory paper trail required for disposal is eliminated and labor is saved in the reduction of transportation of the polyurethane. There is 100% elimination of rolloffs and the maintenance associated with rolloffs.

According to an embodiment of the present invention, polyurethane edge strips are formed in-situ, directly on the stainless steel cathodes. In one exemplary embodiment the edge strips are formed on sheet-like metal blanks, which serve as cathodes, by molding. In another the strips are formed on the blanks by spraying.

Edge areas of the blanks are first sand blasted where the edge strips are to be formed so that the applied polyurethane will be well anchored. A commercially available primer for polyurethane is then applied to the areas to be covered by the polyurethane.

In an embodiment in which the strips are to be molded, mold parts (treated with a release agent) are fitted to the blanks along the edges where the strips are to be formed. Liquid polyurethane is then introduced into the molds in contact with the sandblasted and primed edge areas on both sides of the cathodes and around the edges. The polyurethane can be directed into the mold by gun or a movable tube connected to a pressurized source of the polyurethane. When the polyurethane has set, the mold-forming parts are removed.

When the technique for forming the edge strip is spraying, after sandblasting, the edge areas to be coated are defined by masking. Primer is applied. Liquid polyurethane is then sprayed onto the sandblasted and primed edge areas where the edge strips are to be formed.

Thus created in-situ, the edge strips are continuously adherent to the blanks at the steel-polyurethane interface and little opportunity is afforded for electrolyte to find its way beneath the edge strip to the covered metal portions of the cathode.

If damaged, the edge strips are readily repaired by removal of the polyurethane in the area of the damage. The underlying blank is sandblasted and primed. The mold is reapplied or masking is applied and fresh polyurethane is applied by molding or spraying to repair the damaged area.

In yet a further embodiment, voids in preexisting edge strips are filled with the polyurethane formulation, which advantageously strengthens the edge strips.

### BRIEF DESCRIPTION OF THE DRAWINGS

FIG. 1 is a front plan view of a blank of the kind used in electrorefining of metal and to which edge strips according to this invention are to be applied;

FIG. 2 is a fragmentary perspective view of a prior art edge strip construction and shows a metal nodule growing at the intersection of a corner piece and edge strip side section;

FIG. 3 is an enlarged fragmentary plan view of a blank like that of FIG. 1 and shows an edge area prepped for application of polyurethane;

FIG. 4 is a fragmentary cross-section of a blank and attached edge strip forming mold;

FIG. 5 is a fragmentary front plan view of the strip and mold of FIG. 4;

FIG. 6 is a fragmentary cross-section of a molded in place edge strip on a blank;

FIG. 7 is a schematic illustration of a spray station for spraying polyurethane edge strips onto the blanks; and

FIG. 8 is a fragmentary front plan view of an edge strip, having a void, that is attached to a blank.

### DETAILED DESCRIPTION

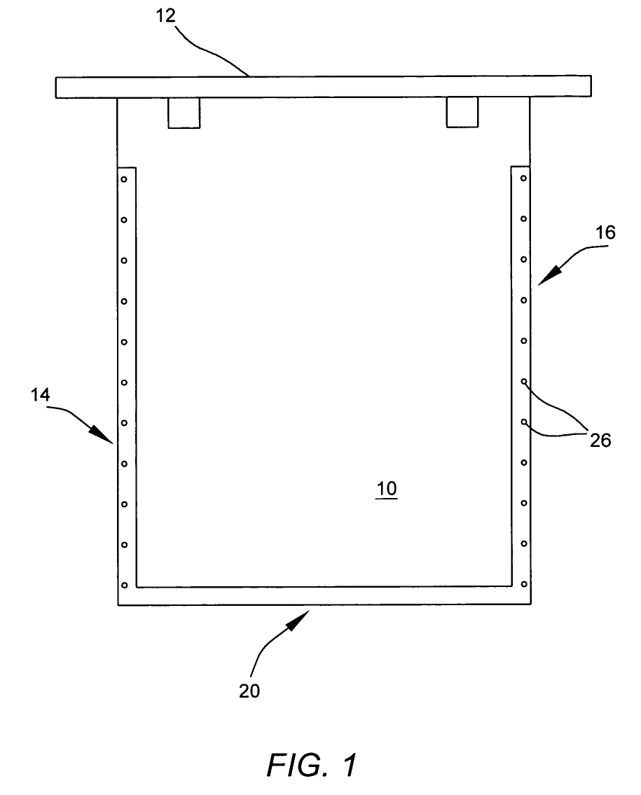

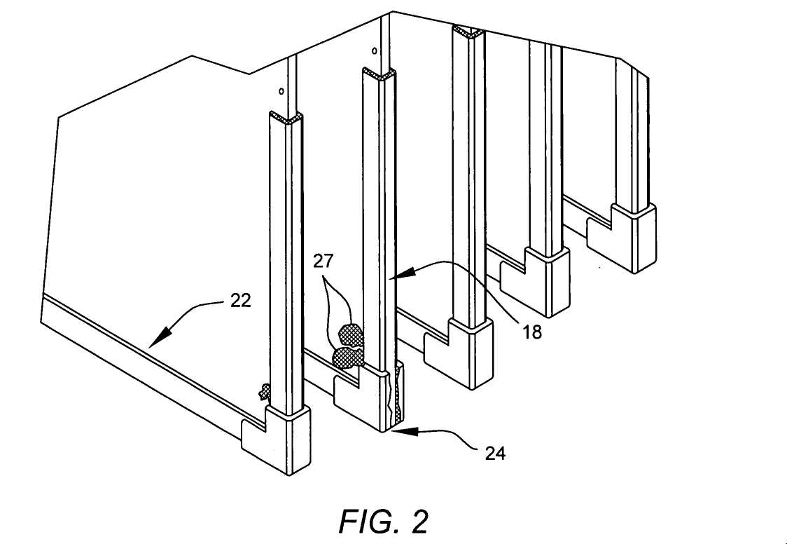

Turning to FIG. 1 a prior art blank 10 is connected at its upper end with a support member 12 from which it is hung into a cell (not shown) of electrolyte solution in an electrolysis operation. Typically the blank 10 has glued along its two side edges 14 and 16 a pair of edge strips, one of which can be seen in FIG. 2 at 18.

Where a three-sided edge strip is employed, a further strip 22 similar to the strip 18 in FIG. 2 is glued along the bottom edge 20 of the blank 10. At corners of the blank 10 corner pieces 24 join the edge strips 18 and 22. In the prior art, as illustrated in FIGS. 1 and 2, all of the edge strips and corner pieces are secured to the blank 10 by an appropriate glue. Seen in FIG. 1, small apertures 26 along the edges of the strip help to secure the strips, both in the prior art and the practice of embodiments of the present invention. Two nodules 27 appear in FIG. 2, one at the intersection of the edge strip 18 and the corner piece 24 and one just above that. These growths signal penetration of electrolyte to portions of the blank intended to be covered by the edge strips, with increasing damage to the edge strip and corner piece.

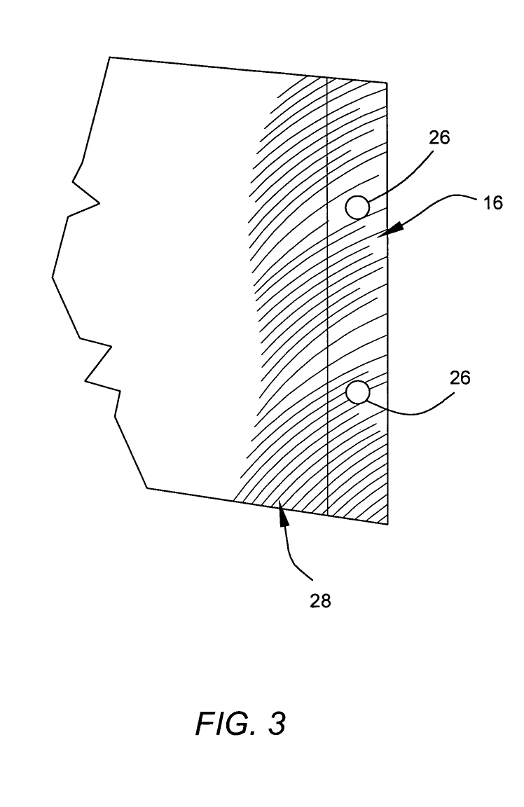

In FIG. 3 the edge 16 of a blank 10 like that of FIG. 1 is shown prepared for application of edge strips in accordance with an embodiment of the present invention. The edges to which the edge strips are to be applied are roughened by sandblasting or by application of a circular abrading tool or equivalent so as to form an anchoring pattern for polyurethane edge strips to be formed in-situ thereon.

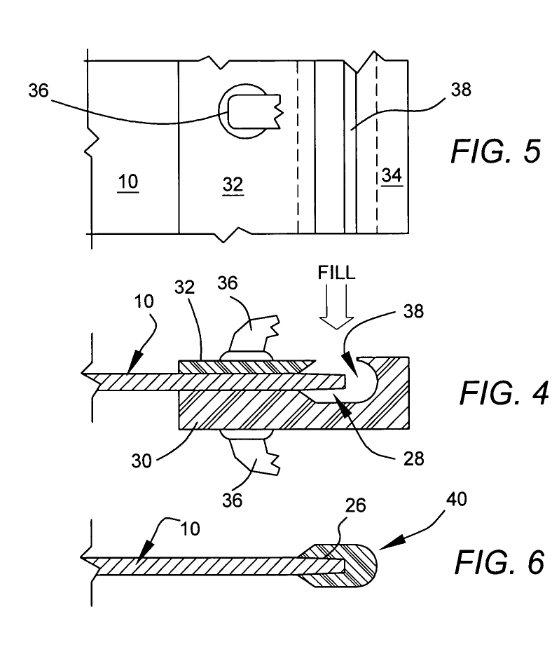

In an exemplary embodiment of the invention, each edge of the stainless steel blank 10 that is to have an edge strip formed along it has a strip at least ⅝ inches in width sandblasted to a 2 mil angled profile as shown in FIG. 4.

Subsequent to sandblasting or otherwise abrading the edges in this manner, a suitable, commercially available polyurethane primer is applied to all edge areas that are to be covered by the edge strips to be formed.

In the exemplary embodiment discussed above, the sandblasted areas are masked with ¾ inch masking tape along the interior borders of the ⅝ inch wide strips and primer is brushed, rollered or sprayed onto the exposed portions of these ⅝ inch wide strips on both sides of the blanks 10. If sprayed on as a solvent diluted solution, the primer is allowed to dry completely. A suitable solvent is acetone sufficient to effect no more than a 5% dilution. If primer is rolled on undiluted, it is allowed to become tacky before any polyurethane is applied. The manufacturer's recommended time window for applying the polyurethane should be strictly observed.

When the edge strips are to be molded in place, polypropylene mold pieces 30 and 32 are first wiped clean using acetone and a clean rag. Mold piece surfaces that will contact the polyurethane have a release agent, such as a silicone spray or a wax applied thereto. The blank 10 is positioned on a mold piece 30. A mold positioning guide (not shown) is run between the mold and blank edge to assure proper positioning. The mold pieces 32 are then clamped along the edges on which edge strips are to be formed as illustrated in FIGS. 4 and 5. Suitable clamps 36 are used for this purpose. These can be vice grips or C clamps or other commercially available clamping devices as desired. Hot liquid polyurethane is introduced into a slot 38 formed between the mold pieces 30 and 32. In an exemplary embodiment, the bottom of the recess formed by the mold parts 30 and 32 and blank edge is filled in a first pass and then the recess is “topped off” in a second pass. The polyurethane is permitted to cool and harden. The polyurethane edge strip 40 thus-formed is shown in FIG. 6. The polyurethane covers a narrow band along each of the faces of the blank 10 and extends around the edge of the blank. Little opportunity exists for the electrolyte to find its way between the edge strip 40 and blank 10. No troublesome joinder of corner pieces with edge strips is employed when three-sided edge strips are formed in this fashion. No bottom plugs are required for two-sided edge strips formed in accordance with this embodiment of the present invention. In the event that damage to one of the edge strips 40 occurs, the area immediately around the damage can be removed, the surface below that portion can be prepped by sandblasting and applying primer, the two mold sections can be brought into place, and fresh polyurethane can be directed into the affected location.

In an embodiment of the present invention, the polyurethane is a polyurethane formulation, such as that used in tank liners. Examples of a suitable polyurethane formulations, for the purposes described herein, are Durabond™ Polyurethane or Hi-Chem™ Polyurethane, both of which are commercially available from Rhino Linings USA, Incorporated, of San Diego Calif. as described at the website http://www.rhinoliningsindustrial.com, incorporated herein by reference.

Desirably, the polyurethane formulation has good abrasion resistance, a strong adhesion to metal substrate and is flexible. In an embodiment, the polyurethane formulation has the following properties: a hardness (shore D) in the range of about 45-70, more particularly about 45-50 for processes using a lower temperature electrolyte solution and about 70 for higher temperature solutions; a tensile strength (psi) in the range of about 2100-2460, more particularly about 2100-2200 for lower temperature solutions and about 2460 for higher temperature solutions; an elongation factor (%) in the range of about 25-80%, more particularly about 50-80% for lower temperature solutions and 25-30% for higher temperature solutions; a Taber abrasion resistance (mg of loss/1000 cycles) of a CS17 wheel and 1000 grams of weight is in the range of about 25-53, more particularly 25-30 for lower temperature solution and 53 for higher temperature solution. It is also desired that the polyurethane formulation has characteristics that will hold up to exposure to 25% sulfuric acid.

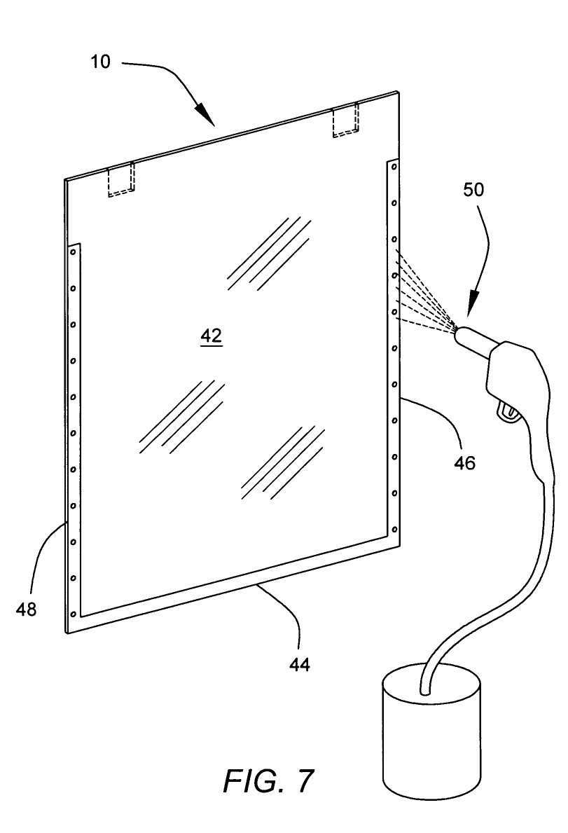

In an alternative application of edge strips in accordance with the invention, as seen in FIG. 7, the blank 10 has locations 42 on each side (one of which is shown) masked. Edge locations 44, 46 and 48 are left unmasked. Prior to masking, these edges 44, 46 and 48 are prepped as described above. Polyurethane primer is applied to the edges where the strips are to be formed. Polyurethane is sprayed as indicated at 50 onto the edge locations of the blank 10. A hand spray gun is diagrammatically indicated at 50 in FIG. 7, but it will be understood that the spraying can be automatically effected in, for example, an electrostatic spray booth.

Again, because of the intimate association of the polyurethane with the underlying portions of the blank 10, little opportunity exists for the electrolyte to invade. If physical damage is done to edge strips so formed, the polyurethane in that area is removed, as previously described. The edge to which polyurethane is to be reapplied is then sandblasted and primed and the blank 10 is then masked and new polyurethane is sprayed in place.

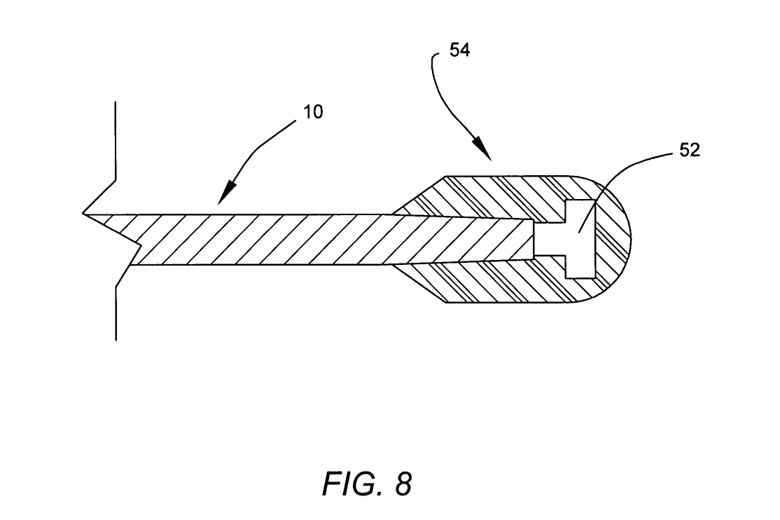

With reference to FIG. 8, a further alternative embodiment includes filling a void 52 of an existing edge strip 54. Many presently used edge strips 54 form a central, T-shaped void 52 when attached to the blank 10. The void 52 aids the edge strip in clamping onto the blank 10. In accordance with the further alternative embodiment, polyurethane is injected into the void 52, which serves to prevent electrolyte from leaking into the edge strip covered portions of the blank 10.

In an alternative application of edge strips in accordance with embodiments of the invention, the edge strips are injection molded around the blank 10. Polypropylene mold pieces 60 and 62 are first wiped clean using acetone and a clean rag. Mold piece surfaces that will contact the polyurethane have a release agent, such as a silicone spray or a wax applied thereto. The blank 10 is positioned to allow the solution to leave the exit holes in the mold at the point of least resistance (e.g., the bottom of the cathode to allow a gravity feed). The mold pieces 60 and 62 are then clamped along the edges on which edge strips are to be formed. Suitable clamps 36 are used for this purpose, such as vice grips or C clamps or other commercially available clamping devices as desired. Hot liquid polyurethane is introduced into a slot (not shown) formed along one edge of the mold pieces 60 and 62. In an exemplary embodiment, both sides of the recess formed by the mold parts 60 and 62 and blank edge is filled in a first pass. The polyurethane is permitted to cool and harden and then the molds 60 and 62 are removed to reveal the finished polyurethane edge strip 40.

While specific preferred embodiments have been described above, it will be readily understood that modifications can be made in the edge strips according to this invention and their method of manufacture without departure from the spirit and scope of this invention. For example, the blank 10 may comprise various types of metals, including stainless steel or aluminum. The metal deposited onto the blanks 10 by electrolysis may include copper, zinc, nickel and cobalt. The polyurethane formulation may include a variety of compositions. Moreover, various methods of electrolysis may be used in connection with the practice of the present invention, including known methods of electrorefining and equivalents thereof. Therefore, the spirit and scope of the appended claims should not be limited to the description of the preferred versions contained herein.

We claim:

1. A combination cathode blank for collecting metal thereon from an electrolyte solution and an edge strip for preventing metal deposition along edges of the blank, comprising:
an abraded edge portion of a cathode blank; and
an edge strip extending along the edge portion in intimate contact with the surface thereof and extending about the edge of the blank,
wherein the edge strip comprises a polyurethane formulation.

2. The combination of claim 1, wherein the polyurethane formulation has an elongation % in the range of about 25% to 80% and a taber abrasion resistance of about 25 to 53 mg of loss per 1000 cycles of CS 17 wheel.

3. The combination of claim 1, wherein the edge strip is an in-situ formed edge strip.

4. The combination of claim 1, wherein the edge strip is an injection mold formed edge strip.

5. The combination of claim 1, wherein the edge portion is a sand blasted edge portion having an angled profile.

6. The combination of claim 1, further comprising a primer between the cathode blank and the edge strip.

7. The combination of claim 1, wherein the edge strip extends partially across a first side edge of the cathode blank, completely across a bottom edge of the cathode blank and partially across a second side edge of the cathode blank, wherein the first side edge and the second side edge are adjacent to the bottom edge.

8. The combination of claim 7, wherein the edge strip is a single piece.

9. The combination of claim 7, wherein the edge strip comprises three separate pieces.

10. The combination of claim 1, wherein the edge strip is a three-sided edge strip.

11. The combination of claim 1, wherein the cathode blank has a sheet-like rectangular shape.

12. The combination of claim 1, wherein the cathode blank comprises aluminum or stainless steel.

13. The combination of claim 1, wherein the cathode blank is capable of collecting a metal via electrolysis selected from the group consisting of copper, zinc, nickel and cobalt.

14. A method of forming an edge strip on a cathode for collecting a metal thereon from an electrolyte composition, comprising:
(a) providing a sheet-like cathode blank,
(b) abrading narrow edge regions on the blank,
(c) applying to the narrow edge regions a primer, and
(d) applying polyurethane to the narrow edge regions to form an edge strip thereon in intimate relation with surfaces of the narrow edge regions.

15. The method of claim 14, further comprising placing one or more mold pieces along the edge regions.

16. The method of claim 15, wherein step (d) is performed by introducing the polyurethane into the mold pieces.

17. The method of claims 15 and 16, further comprising removing the mold pieces from the edge regions after the edge strip is formed.

18. The method of claim 14, wherein step (c) is performed by spraying the primer via a hand spray gun.

19. The method of claim 14, wherein the blank has a preexisting edge strip.

20. The method of claim 19, wherein further comprising removing the preexisting edge strip prior to step (b).

21. The method of claim 14, wherein step (c) is performed by spraying the primer via an electrostatic spray booth.

22. The method of claim 14, wherein step (d) is performed by injection molding.

23. The method of claim 14, further comprising collecting a metal on portions of the blank via an electrolysis process.

24. The method of claim 23, wherein the metal is copper, nickel, zinc or cobalt.

25. A method of forming an improved edge strip on a cathode blank, comprising:
(a) providing a sheet-like blank;
(b) providing an edge strip attached to at least a part of an edge of the blank, wherein the edge strip and blank form a central void; and
(c) injecting polyurethane into the central void, substantially completely filling the void.

26. The method of claim 25, wherein the void is t-shaped.

27. The method of claim 25, wherein the injected polyurethane prevents electrolyte from contacting edge strip covered portions of the blank when the blank is inserted into an electrolyte solution.

28. The method of claim 25, wherein the blank comprises stainless steel or aluminum.
